(19) United States
(12) Patent Application Publication
(10) Pub. No.: US 2005/0043964 A1
(43) Pub. Date: Feb. 24, 2005

(54) Data processing system for patent data

(76) Inventors: Christian Thielscher, Bergisch Gladbach (DE); Martin Gottfried, Konigstein (DE); Simon Umbreit, Oberstenfeld (DE); Frank Boegner, Remseck (DE); Jochen Haack, Frankfurt am Main (DE); Nikolai Schroeders, Frankfurt am Main (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/492,298

(22) PCT Filed: Oct. 9, 2002
(86) PCT No.: PCT/EP02/11305

(30) Foreign Application Priority Data
Oct. 11, 2001 (DE) 101 50 008.4
Feb. 27, 2002 (DE) 102 09 780.1

(51) Int. Cl. G06F 17/60; H04K 1/00; H04L 9/00

(52) U.S. Cl. 705/2; 705/50

(57) ABSTRACT

Data processing system for patient data.

The invention refers to a data processing system for the processing of patient data, which includes person identifying data of a respective patient and corresponding health data (GD), with a central system (3), which includes a database (4) storing the health data, and with terminal devices (1), which are connected with the central station for the request of health data from the database and/or for the input of health data into the central database. According to the invention, health data is stored in the central database without assignment to person identifying data, a data record identification code (DIC) being assigned to a health data set of a respective patient, where a retrieval of the health data set necessitates the input of the corresponding data record identification code. The invention can be used e.g. for a system managing patient data records.

### BACKGROUND AND SUMMARY OF THE INVENTION

The invention refers to a data processing system for the processing of patient data that include person identifying data of each patient and the corresponding health data. The system includes one or several central locations. Each central location consists of a database storing health data and entry devices linked to the database. The health data of patients can be retrieved from the database and/or stored in the database through the entry devices.

In recent times, attempts in health services increase to improve the treatment of patients cost efficiently through an optimized processing of health data, i.e. the data describing health status and treatment of each respective patient. To that, a cross-linked data processing system is useful, through which the different health professionals involved in the treatment of a patient, such as physicians, pharmacists, as well as payors of the treatment, like health insurances, are able to more efficiently obtain access to the specific health data they need. Such systems are currently discussed under the keyword “electronic health record”.

However, a patient's health data is highly sensitive and, therefore, must be subject to very strict data protection in order to avoid that non authorized people involved in the treatment or other persons might get access to stored health data. The technical problem underlying the invention is to provide a unique data processing system for the processing of patient data in which the health data is stored in a central database with very high protection from non authorized access.

The invention solves this problem by providing a data processing system. In this system the health data is stored without assignment to personal patient data in the respective central database, making it impossible for unauthorized persons—even if they would be able to retrieve health data from the database—to assign that data to specific individuals.

The authorized retrieval of health data of a respective patient requires the input of an individual data record identifier code assigned to the patient. Through this code specifically a corresponding health data record can be retrieved from a central database, however, this code is detached from person identifying data. This means that the retrieved health data cannot be assigned to a specific person by this code alone. In this way it is accomplished that the retrieved health data cannot be assigned to a specific individual without the individual's cooperation and/or approval. To give approval, appropriate authorization means can be made available to the patients with which patients can enable, for example a physician, to retrieve the required health data from the central database using the respective data record identifier code. Through this invention, an efficient centralized storage and administration system for health data records is achieved on the one hand, which, on the other hand, offers very high protection from unauthorized persons to access personalized health data.

In a further aspect of the invention, the data record identifier code required for retrieval of a respective health data record includes a patient card code stored on an electronic patient card plus a patient identification code (PIN) to be entered by the patient. Therefore, retrieval of data requires both, the appropriation of the electronic patient card through the patient and the patient's input of his/her patient identification code. In consequence, data retrieval is safeguarded by a double protected cooperation of the patient.

In a further aspect of the invention, the data record identifier code includes a patient card code stored on an electronic patient card plus an identification code of the health professional, e.g. a physician, which identifies the health professional who requests the data. By requiring the additional input of the health professional identification code for retrieving health data, the system can check which health professional has requested health data and when.

In a further aspect of the invention, transfer of the data record identifier code and/or transfer of the health data retrieved from the central database is executed in encrypted mode. This provides protection from unauthorized interception of the data record identifier code and/or the health data retrieved from the database and, thereby, further increases the data protection.

In a further aspect of the invention, the system provides the end-user of the terminal device, in particular the health professional, e.g. the physician, with limited authorization by time to upload new or updated health data records of a patient into the central database, following a login or retrieval which has been determined through the data record identifier code to be authorized and in which the patient has to participate. This process enables the health professional involved in the treatment to enter new health data into the central database within a certain time period, for example a few weeks or months, after seeing the patient without the patient having to be present at the time the data is entered.

In a further aspect of the invention, the electronic patient card contains a picture identifying the person. The health professional involved in the treatment can match this picture with the person presenting the card to him in order to prove the person's identity. This avoids abuse of the card.

In a further aspect, the system includes a pseudonymization computer within the central system. This computer is physically separate from the central database, i.e. has no online-connection with this database. The pseudonymization computer includes a matching table of person identifying data on the one hand and data record identifier codes on the other hand. In order to input health data of a respective patient into the central database, the health data is—preferably encrypted—transmitted together with the respective person identifying data to the pseudonymization computer of the central system. The pseudonymization computer then replaces the person identifying data with the corresponding data record identifier code and provides this code together with the received health data for online transmission to the respective central health record database where it is stored for later retrieval. The physical separation of the pseudonymization computer from the health record database makes it impossible for unauthorized persons—even if they might succeed to break into the data of the database—to gain health data assigned to individual persons.

In a further aspect of the invention, an input computer or gateway system is provided physically separate to the pseudonymization computer in the central location. The user-sided terminals can connect to the gateway system online. The gateway system receives—preferably encrypted and sent with the above mentioned time-limited authorization for data input—health data to be stored, together with the corresponding person identifying data from the user-sided terminals. The gateway system provides the data at an output for offline transmission to the pseudonymization computer. In this way, the pseudonymization computer is physically completely separate from user-sided terminals and the corresponding data network. This assures that the stored table assigning the person identifying data to the data record identification codes is completely secure from unauthorized online access.

In a further aspect of the system, some part of the individual health data of the patient, stored in the central database, is also retrievably stored on the patient card directly. This provides a health professional involved in the treatment with the opportunity to learn about the health status of a patient through the card, for example in case of an emergency, if the patient is not able to cooperate to grant access to the central database.

In a further aspect of the invention relevant for emergencies, the system includes an emergency call center. This call center has authorized access to the central database for requests and reading of data in case of an emergency, when the patient is not able to cooperate to grant access to his health record, and provides such data to the health professional involved in the treatment. The health professional has to authorize himself to the call center using appropriate means of authorization.

### BRIEF DESCRIPTION OF THE DRAWINGS

Advantageous embodiments of the invention are presented in the figures and are described below:

FIG. 1 shows a schematic block diagram of the relevant components for data requests from a system for processing patient data,

FIG. 2 shows a schematic block diagram for an alternative of system of FIG. 1, and

FIG. 3 shows a schematic block diagram of the relevant components to input data into the systems according to FIG. 1 and FIG. 2.

### DETAILED DESCRIPTION

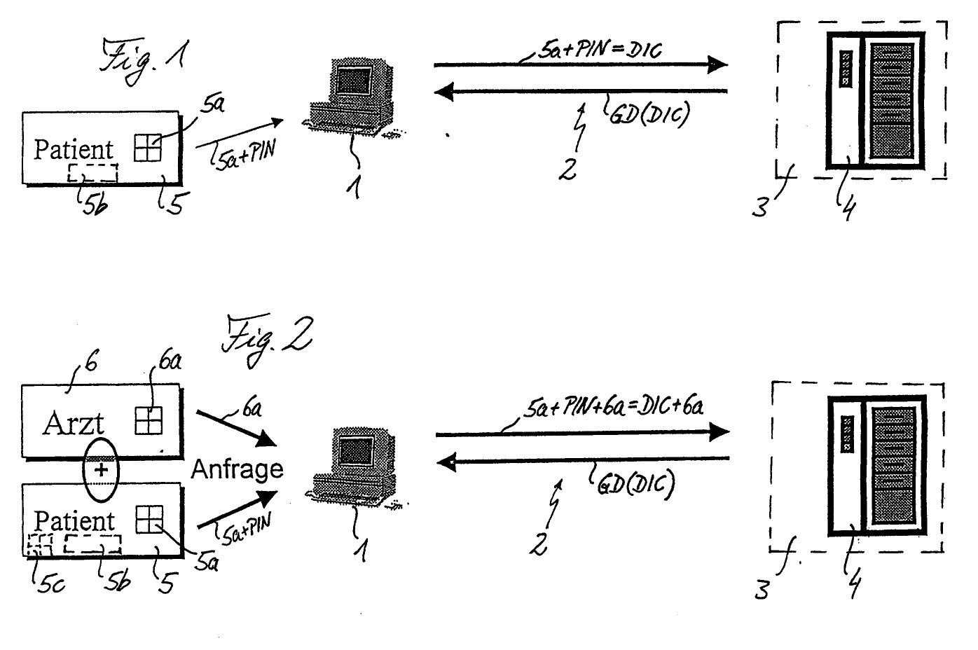

FIG. 1 schematically illustrates the relevant components of a data processing system for processing patient data required to read data, and a data read process carried out therewith. The system includes a data network which contains a plurality of user-sided terminal devices, usually, many user-sided terminal devices, which are connected to a central system 3 via online connections 2. In FIG. 1 only terminal device 1 is representatively shown in the form of a personal computer (PC) 1. The central system 3 includes a source computer 4 that functions as a central health database. As needed, many central systems with respective databases can be setup as a decentralized, distributed system. In the health database 4 the health data of a respective patient is filed in call-up mode as a health data record together with an individually assigned data record identifier code. The health data may consist of electronic prescriptions, doctor's letters, lab data, radiographs, etc. The data record identifier code is composed in a way that no reference to the identity of the patient is possible from its knowledge alone. In this way it can be secured that an unauthorized person is not able to identify for which patients health data is stored and which health data belongs to a specific patient, even if he might be able to request data from the database 4 unauthorized.

This assignment of retrieved health data to specific patients requires the respective patient's active cooperation—except for the cases of emergencies described below—for which the system has a specific design. For this purpose, the system in the basic version, as illustrated in FIG. 1, includes an electronic patient card 5 for every patient. On this card a patient card code 5a is stored. This code can also be described as the patient's card number. For a further improvement of data protection every patient—as a user of the system—receives a personal identification number or code (PIN), that is only known by the patient himself. This PIN helps to make sure that the user retrieved health data refers to the respective patient, i.e. unauthorized possession of a patient's card 5 does not enable request of the health data record. Instead of such a PIN an alternative code securely identifying a person can be used; for example, a code that includes a particular biometric personal feature.

The card number 5a and the PIN together form the data record identifier code (DIC) together with which the appropriate health data record is stored in the central database 4 and that is to be transmitted for a successful data retrieval. For that purpose, the patient card 5 is inserted into a user-sided terminal device. e.g. in the physician's office, for reading the card number 5a. In addition, the patient enters his/her PIN. The terminal device 1 transmits the card number 5a plus the PIN as the DIC to the central system 3 in order to request the return-transmission of the respective patient's health data record.

The central system 3 checks the transmitted DIC with the database source computer 4 for agreement with one of the stored DICs and sends—in the case of found agreement—the corresponding health data record GD(DIC) to the inquiring terminal device 1. Even if this data transfer would be monitored by an unauthorized person, he/she would not be able to assign the health data GD(DIC) to a specific person since they do not contain any person identifying information. Even if an unauthorized person would somehow catch the DIC, this would only allow to access the health data belonging to that specific DIC from the database 4, but he or she could not determine to whom the health data belongs.

For an unauthorized person it is not possible to break through the anonymity of the data even if the unauthorized person breaks into the terminal devices 1 located by the health professionals involved in the treatment, because the professional and his terminal device 1 do not know either the patient's card number 5a nor the patient's PIN.

The patient card 5 can be distributed upon request, for example, through a trust center, i.e. an institution authorized to issue secure certificates, or through a health insurance or some public institution. Consequently, this data processing system for patient data is sufficiently safeguarded against unauthorized accesses to the data. As required, further data protection measures can be realized of which some are described subsequently.

For example, as a security enhancing option the patient card can include a person identifying picture 5b, so that the health professional involved in the treatment can check whether in fact the card 5 presented to him by the patient is the patient's own which precludes to abuse and mistakes.

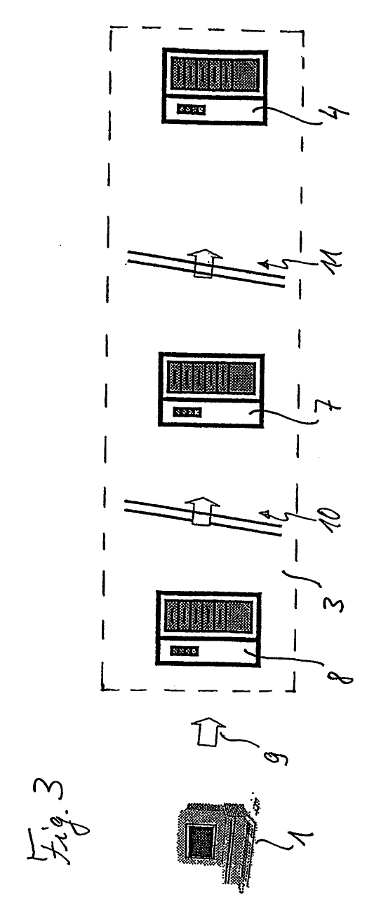

FIG. 2 illustrates a variant of the system of FIG. 1. In this case, the health professional involved in the treatment (e.g., the physician) is provided with his or her own health professional card 6 that includes a health professional identification code 6a. If patient data is requested from the central database 4, the request is processed as in the case of FIG. 1 with the exception that in addition the health professional has to insert his card 6 into the terminal device which then reads the health professional identification code 6a and transmits the same plus the patient identification code 5a and the PIN of the patient—preferably in encrypted form—to the central system 3. Through this measure it can be monitored which physician or other health professional (pharmacist, health insurance, etc.) has requested what data at which point in time.

In both variants data transfer through the online-connection 2 occurs preferably, although not necessarily, in encrypted form. Preferably both, the transfer of the inquiring code data 5a, patient PIN, health professional code 6a, and the retrieved health data GD are encrypted. For that purpose traditional cryptographic means can be used.

For this application a particularly efficient method with very high data protection is to implement an encryption algorithm 5c in the electronic patient card 5 (see dotted line in FIG. 2 as an option). In this case the patient card 5 is designed such that after insertion in the device 1 it reads the PIN typed in by the patient and, when available, the health professional identification code 6a. Then, the encryption algorithm 5c generates, for example using a random generated code, an encrypted information which contains the patient card number 5a, the PIN and the health professional identification code 6a, e.g. a health professional card number, all in encrypted form. This encrypted information is transmitted to the central system 3 via terminal device 1. A corresponding deciphering algorithm is implemented in central system 3 which decrypts the transmitted information. This solution has the advantage, that the patient's card number 5a can be implemented in a way that it is impossible to read it from the card 5. Thus, card number 5a remains a complete secret. Through this design the patient card number 5a cannot be read by a reader of the terminal 1 and unauthorized interception of the patient's card number 5a through the terminal 1 remains impossible.

For the return transfer of the requested health data, for example, a traditional encryption system can be used with a secret code key (“private key”) for the user and a specific non-secret key (“public key”) for the central system. In this case the public keys of all authorized terminal devices 1, respectively of all health professionals and the data record identifier codes (DICs) in pseudonym form are present in the central system 3. The central system 3 transmits the health data (GD) encrypted using the specific public key, to the requesting terminal device 1. At the terminal 1 the data is decoded by using the respective private key. The specific private key may be composed of the secret keys of the patient card (5) and if provided, of the health professional card 6. After this secure process, the health data (GD) can be displayed and analyzed.

FIG. 3 illustrates the relevant components of a very favorable system solution with regards to high data protection for the input of new health data from a terminal device 1 into the central database 4 of the central system 3. In this solution the central system 3 includes the database forming source computer 4 plus a pseudonymization computer (also called anonymization computer) 7 plus an entry computer server 8. It is characteristic of this solution that the pseudonymization computer 7 is physically separate from both the source computer 4 and the entry server 8. Thus, data transfer from entry server 8 to pseudonymization computer 7 and from there to source computer 4 is processed through a specific offline connection 10, 11 only, e.g. in conventional batch-processing. This system design prevents any unauthorized online access to the pseudonymization computer 7.

A main task of the pseudonymization computer 7 is to replace in incoming data, which contain person identifying data and corresponding health data, the person identifying data with the respective patient's DIC. The purpose is to provide at the output completely pseudonymized, respectively anonymized health data for filing in the database 4. In case of an authorized request, the pseudonymized data can then be assigned to the right patient using the DIC.

In a basic version of the system new health data of a patient together with data which identify the patient are transmitted by the health professional from his terminal 1 through an online connection 9 to the central system 3. This online connection 9 can be the same as the connection 2 that is used for data requests or any other connection of the network. The entry server 8 receives the person identifying data and health data and provides it for offline export to the pseudonymization computer 7.

The pseudonymization system 7 receives the offline transferred data and, as mentioned above, replaces the person identifying data with the DIC of the respective patient in order to provide the health data together with the data record identifier code (DIC) at the output for further transfer. For this purpose, an assignment—, respectively translation—, table is implemented in the pseudonymization computer 7, which assigns person identifying data (name, date of birth, etc.) the individual DIC of the respective patient. The data are transferred in a format which allows for automatic deletion of the person identifying data and its replacement with DICs. In the next step, the health data and code are transferred to the data base 4 through the offline connection 11 and filed there. From the central database 4 the health data for a specific patient can be retrieved, as needed and described in FIGS. 1, and 2, through an authorized request. Such request must include the transfer of the correct data record identifier code DIC.

In order to give a health professional the opportunity to file health records in the central database 4 after the examination of a patient for a certain time period only, the system—in a version with further increased data protection—is configured such that the central system 3 transmits together with the health data GD, which the health professional requests while the patient is present, an individual data entry permit code—preferably in encrypted form. This data entry permit code is valid for an adjustable time period, for example a few weeks or months. It gives a health professional the opportunity to transfer health data of his patient within this time period even if the patient is not present in the way described with FIG. 3 to the central database 4 and file it there.

This process differs from the data up-load as described in its basic version in FIG. 3. Instead of transmitting the health data together with the person identifying data, the health data are transmitted with the individual data entry permit code of the respective health professional's patient from terminal device 1 to entry server 8 and from there in online mode to pseudonymization computer 7. Computer 7 replaces the data entry permit code, which is limited by time, with the DIC of the patient, using an assignment table correspondingly stored therein. In case the health professional intends to upload health data to central database 4 after his permit has expired, this has to be executed in another safe process, for example, by sending the health record by mail, in which case it is electronically processed in the central system 3, or through another highly protected electronic data transfer mode.

Alternatively or in addition to giving health professionals a time limit for the upload of health data into the central database 4, the process described in FIG. 3 can be modified in order to achieve an even higher data protection by transmitting data encrypted through online connection 9, for example by one of the encryption algorithms explained in FIGS. 1 and 2.

The system design as described so far allows a health professional to retrieve data from the central database 4 only in the presence of the individual patient. In order to make the necessary health data available to a health professional in case of emergency at any time, the system includes one or several suitable emergency measures.

In a first emergency measure, such health data which is usually required of a patient in case of emergency, is stored for retrieval directly on the electronic patient card 5—e.g. data about blood group, allergies, currently taken drugs/medicine, diagnoses relevant during emergencies, etc. A health professional can access the relevant data by means of the patient card only in case of emergency.

As a further emergency measure the system can include an emergency call center which has the authorization for access to at least an emergency-relevant part of the health data of every patient stored in the central database 4. In the event of an emergency, the health professional has to verify his authorization to the call center. For this purpose, every health professional receives an individual authentication code. After authentication he receives the required emergency health data. To maintain sufficient data protection, it is meaningful that the patient must agree with this emergency right for access to his health data ahead of time. In addition, the patient must be informed about each emergency request afterwards. In the case of a loss of the patient's card or the health professional's card these cards are made invalid by the owner through a conventional way as known, e.g., from credit cards. For example, the owner calls the central system 3 which checks the authorization of the caller (e.g., through recall and/or security information, known to the caller only).

The embodiments explained above make it clear that this invention provides a data processing system for the processing of patient data with so-called electronic health records in a practical form that, in addition, meets an extremely high data protection standard required for such data.

1. Data processing system for processing patient data that include person identifying data of a respective patient and corresponding health data comprising:
a central system having a database storing health data and
terminal devices connected with the database for the retrieval of health data from and/or for the upload of health data into the central database
wherein the health data are stored in the central database without assignment to person identifying data, a data record identification code (DIC) being assigned to a health data set of a respective patient, where a retrieval of the health data set necessitates the input of the corresponding data record identification code.

2. Data processing system according to claim 1, wherein the DIC includes a patient card code which is stored on an electronic patient card and a person identification code (PIN) to be entered by the patient.

3. Data processing system according to claim 1, wherein the DIC includes a patient card code, which is stored on an electronic patient card, and a health professional identification code.

4. Data processing system according to claim 2 comprising:
means for encrypted transfer of the DIC and/or means for encrypted transfer of health data retrieved from the central database.

5. Data processing system according to claim 1, comprising:
a data entry code limited by time, which code is transmitted together with the respective health data by the central system to the requesting terminal device, when retrieving health data.

6. Data processing system according to claim 2, wherein the patient card includes a patient identifying picture.

7. Data processing system according to claim 1, wherein the central system includes a pseudonymization computer, which is physically separate from the central database, which pseudonymization computer contains an allocation table with person identifying data and the corresponding DICs, and which receives the health data input together with the corresponding person identifying data, replaces the person identifying data with the corresponding DIC, and outputs the health data together with the corresponding DIC for filing in the central database.

8. Data processing system according to claim 7, wherein the central system including includes an entry server which is physically separate from the pseudonymization computer and to which the terminal devices are connected via an online link and which provides at its output side data transmitted by the terminal devices for offline transfer to the pseudonymization computer.

9. Data processing system according to claim 2, wherein a selectable part of the health data for the respective patient is stored for direct retrieval on the patient card.

10. Data processing system according to claim 1 comprising:
an emergency call center connected with the central system for authorized retrieval of at least an emergency-relevant part of the health data of every patient, authentication means being provided for authentication of health professionals at the emergency call center in order for them to request an authorized emergency reading of health data.

11. A data processing system for processing patient data that include person identifying information of a respective patient and corresponding health information comprising:
a central system comprising
a pseudonymization computer which receives incoming data containing person identifying data and corresponding health data, and replaces the person identifying data with a data record identification code; and
a central database which receives and stores health data and corresponding data record identification codes,
wherein the pseudonymization computer is physically separate from the central database.

12. The data processing system according to claim 11, wherein the central system comprises:
an entry server which receives person identifying data and corresponding health data from terminal devices, wherein the entry server provides the person identifying data and the corresponding health data to the pseudonymization computer in an offline transfer, and wherein the entry server is physically separate from the pseudonymization computer.

13. The data processing system according to claim 11, wherein the pseudonymization computer includes a translation table for translating person identifying data to a data record identification code.

14. The data processing system according to claim 11 comprising:
a terminal device with an input for receiving an electronic patient card and person identifying code, wherein the terminal device retrieves health data from and/or uploads health data to the central system.

15. A method for processing patient data comprising:
receiving a request for a health data set of a patient, the request including a data record identification code;
retrieving the health data set from a database using the data record identification code; and
sending the retrieved health data set,
wherein the health data set is stored in the database without assignment to person identifying data.

16. The method of claim 15 comprising:
receiving, by a pseudonymization computer, a new health data set and corresponding person identifying data;
replacing the person identifying data with a corresponding data record identifying code; and
storing the new health data set along with the corresponding data record identifying code in a central database, wherein the pseudonymization computer is physically separate from the central database.

17. The method of claim 15 comprising:
receiving an electronic patient card and a person identification code;
forming a data record identification code using information on the electronic patient card and the person identification code; and
transmitting a request for the health data set, the request including the data record identification code.

18. The method of claim 15 comprising:
receiving an electronic patient card which includes a patient card number and a person identification code;
receiving a health professional identification code;
encrypting the patient card number, the person identification code and the health professional identification code to form encrypted information; and
transmitting a request for the health data set, the request including the encrypted information.

19. The method of claim 18 wherein the retrieved health data set is sent in an encrypted form.
